(19) United States
(12) Patent Application Publication
(10) Pub. No.: US 2004/0075996 A1
(43) Pub. Date: Apr. 22, 2004

(54) Decoration device of a wax lamp with shadowy variations

(76) Inventor: Kevin Lee, Taipei (TW)

Correspondence Address: Lipan Industrial Co., Ltd., P. O. Box No. 6-57, Chung-Ho, Taipei, 235, TW

(21) Appl. No.: 10/271,995

(22) Filed: Oct. 17, 2002

(51) Int. Cl. F21V 33/00

(52) U.S. Cl. 362/101; 362/161; 362/806

(57) ABSTRACT

A decoration device of a wax lamp with shadowy variations provided for decoration and appreciation as well as capable of self-projecting multiple and shadowy decorative floats. The invention is formed by having a casing with a beautiful outer shape sealed on the outside thereof to fit with relevant members, such as a power source supplier, a heating coil and a decorative float vessel disposed inside the casing as well as a curved reflecting device; wherein the reflecting device mainly has reflecting mirror functions, such as a mirror surface, a sheet of tinfoil paper and a shinning metal. Furthermore, the reflecting device is combined by variably arranging a horizontally curved surface, a vertically curved surface, a vertical wave or layers of lens according to the need thereby enabling the decorative floats expand from a linear and reciprocating motion to achieving a function of producing full-area, multiple and variable shadows.

### BACKGROUND OF THE INVENTION

1) Field of the Invention

The present invention relates to a decorative device of a wax lamp with shadowy variations, more particularly to a structure for a wax lamp provided for decoration and appreciation. The design is to have a casing with a beautiful outer shape sealed on the outside thereof to fit with relevant members, such as a power source supplier, a heating coil and a decorative float vessel disposed inside the casing as well as a curved reflecting device; wherein the reflecting device mainly has a reflectible structure, such as a mirror surface, a sheet of tinfoil paper and a shinning metal. Furthermore, the reflecting device is combined by variably arranging a horizontally curved surface, a vertically curved surface, a vertical wave or layers of lens according to the need so as to operate an planar effect of the present invention of a decorative device of a wax lamp with shadowy variations.

2) Description of the Prior Art

Along with the advance and popularity of science and technology, elements of artistic decorations created thereby have been developed in multiple styles. According to the current trend, a decorative wax lamp device is one of the most popular merchandises with decorative floats since it has the advantages of being trendy, innovative and requiring no movement for displaying the floating decorations.

As shown in FIG. 1, decorative floats (40) of a decoration device of a conventional wax lamp are located inside a tube (11) of a casing (1); a transparent liquid is poured into the tube (11). After being heated, the transparent liquid starts to connect to make the decorative floats (40) drift reciprocatively; it fits with the disposition of a casing window (10) so as to form a decorative wax lamp device for visual enjoyment.

However, from either visual, artistic or practical point of view, the decorative floats (40) of the wax lamp formed accordingly can only change in linear reciprocative motions due to an straight post outer shape of the tube (11); therefore, it has some drawbacks in the basic structure required fundamentally by the visual development.

In addition to the abovementioned problem of the limited bottle neck in a practical application, more disadvantages have existed for years in actually using the conventional wax lamp with decorative floats moving in a monotonous, linear and reciprocative flow scope; more particularly, the excessive simple and repetitive decorative floats (40) are really unable to achieve the function of making shadowy variations.

### SUMMARY OF THE INVENTION

Therefore, the inventor of the invention has engaged in many tests and experiments aiming at developing a structure capable of centralizing functions, eliminating simple, repetitive, linear and reciprocative floating as well as achieving the objectives of having the ability to make area instead of linear shadowy variation for decoration with high value; not only the augmented functions do not highly increase the manufacturing cost, the special structure of the present invention is capable of effectively achieving the innovative usage of the entire space, enhancing the advance and value added through extending the motion of decorative floats thereof from linear movements to full-area and multi-shadowy variations.

To enable a further understanding of the structure, method, spirit and the other objectives of the present invention, the brief description of the drawings below is followed by the detailed description of the preferred embodiment.

### BRIEF DESCRIPTION OF THE DRAWINGS

FIG. 1 is an orthographic, plan view, schematic and status drawing of a decoration device of a conventional wax lamp.

FIG. 2 is an external view, pictorial and schematic drawing of a preferred exemplary embodiment of the present invention.

FIG. 3 is an external view, pictorial, exploded and schematic drawing of the preferred exemplary embodiment of the present invention.

FIG. 4 is a bird's-eye view, plan view and schematic drawing of a reflectible device of the preferred exemplary embodiment of the present invention.

FIG. 5 is a lateral view, plan view and schematic drawing of the reflectible device of the preferred exemplary embodiment of the present invention.

FIG. 6 is an orthographic, plan view, schematic and status drawing of the preferred exemplary embodiment of the present invention.

FIG. 7 is a lateral view, plan view and schematic drawing of another preferred exemplary embodiment of a reflectible device of the present invention.

FIG. 8 is a lateral view, plan view and schematic drawing of yet another preferred exemplary embodiment of a reflectible device of the present invention.

FIG. 9 is a lateral view, plan view and schematic drawing of still another preferred exemplary embodiment of a reflectible device of the present invention.

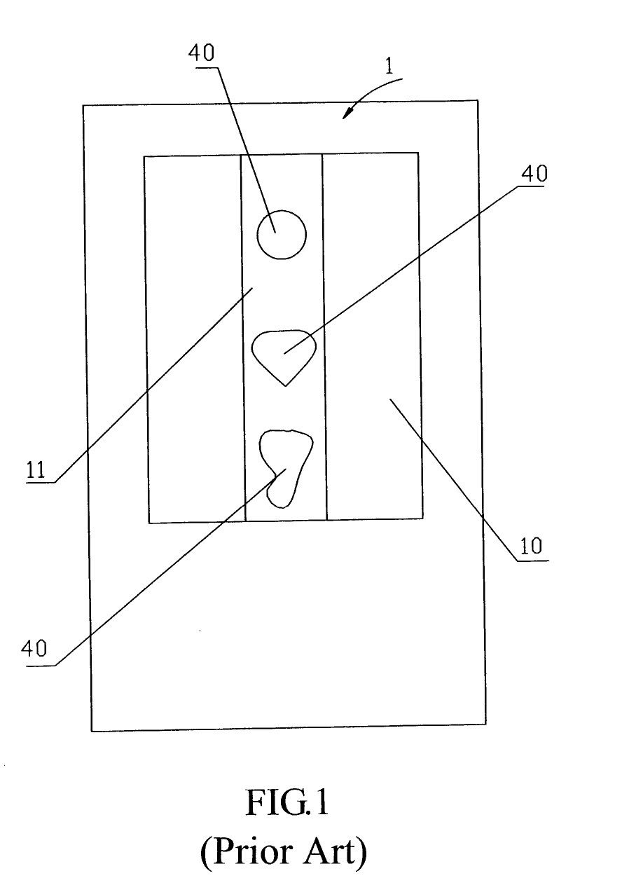

### DETAILED DESCRIPTION OF THE PREFERRED EMBODIMENTS

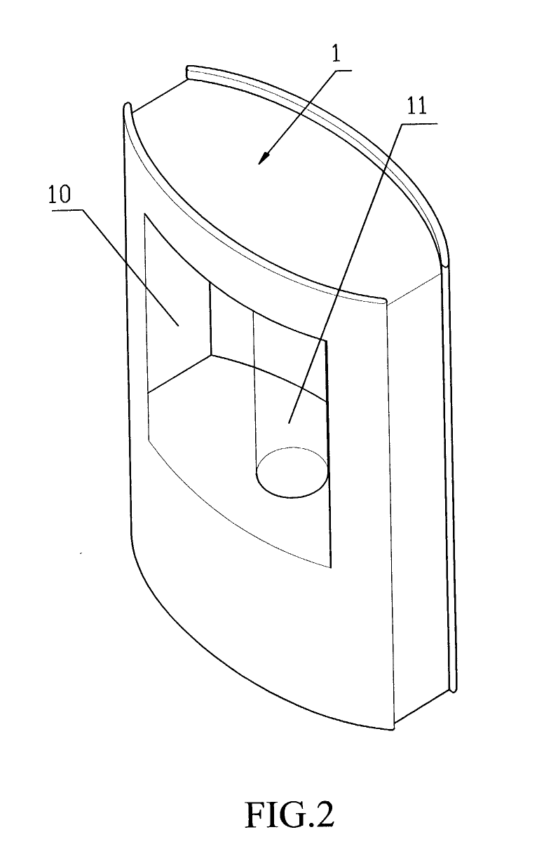

Referring to FIGS. 2, 3, 4 and 5, the design of present invention of a decoration device of a wax lamp with shadowy variations mainly comprises a casing (1) with a beautiful and curved outer shape formed according to the need to seal onto the outside thereof and to fit with relevant members, such as a power source supplier (2), a heating device (3) and a decorative float vessel (4) disposed inside the casing (1) as well as a curved reflecting device (5) affixed onto an inner wall surface opposite to a window (10) of the casing (1); wherein the casing (1) has a transparent window (10) for a viewer to see a group motion of decorative floats (40); an accommodation space is disposed inside the casing (1) through the window (10); one or more than one tube (11) is disposed to penetrate around the central position area of the accommodation space. A bottom plane at an upper end of the tube (11) seals at the top end of the accommodation space opposite an inner wall surface of the casing (1); a bottom rim at a lower end of the tube (11) penetrates the accommodation space to communicate with an opening at an upper end of the decorative float vessel (4); a transparent liquid, such as water, is poured into the tube (11) and the communicated decorative float vessel (4).

The power source supplier (2) fits with the heating device (3); when it is necessary, the power source supplier (2) provides equal electric current kinetic energy onto the heating device (3) and a proper amount of temperature to the bottom end of the decorative float vessel (4).

The opening rim at the upper end of the decorative float vessel (4) is in communication with the tube (11); the connected inner space between them is filled with a transparent liquid, such as water, and dispersed with the decorative floats (40) for visual enjoyment; the decorative floats (40) are either made of colored liquid object, such as melted wax, with different density from that of the transparent liquid, or made of a transparent liquid with floating solid bodies and gas, or mixture of both inside.

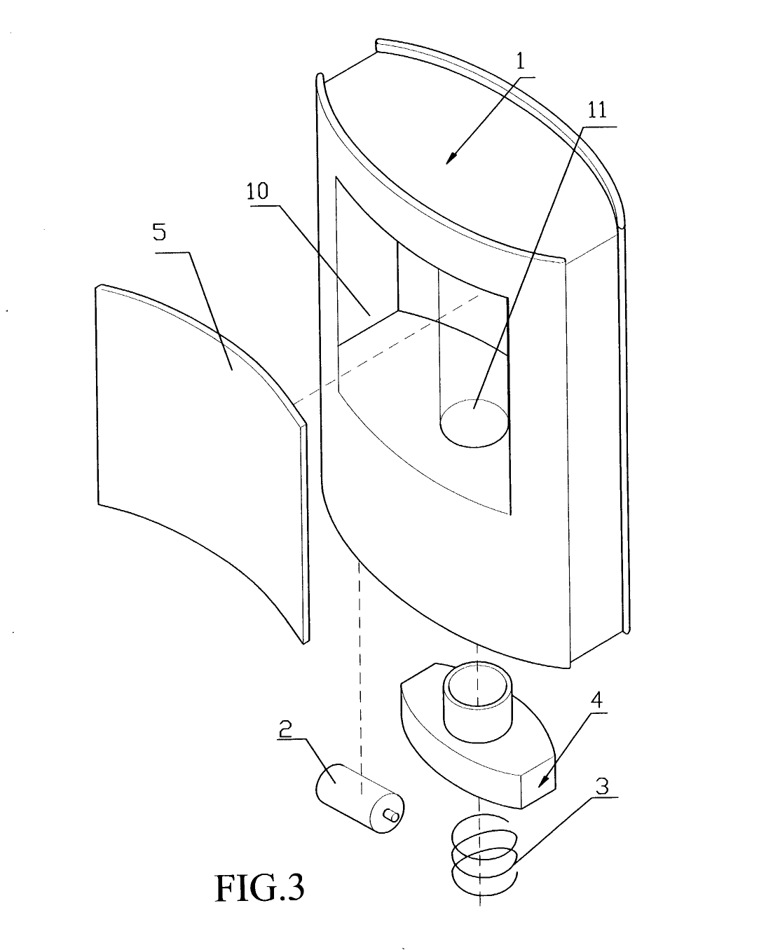

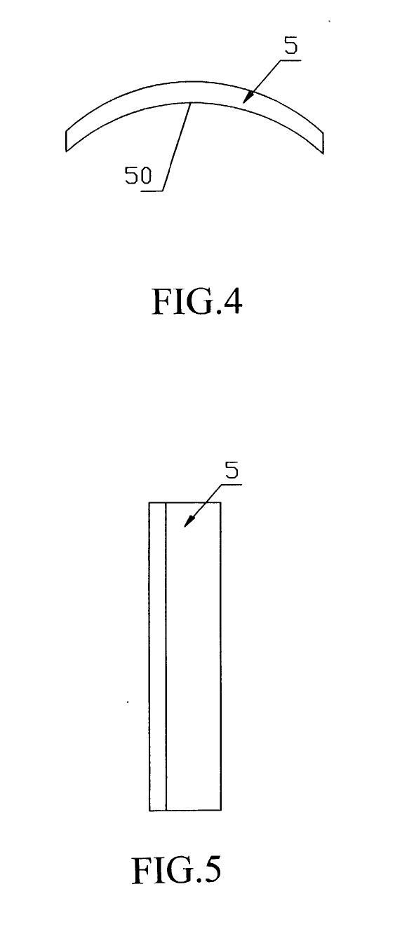

The reflecting device (5) mainly has structures with reflecting mirror functions, such as a mirror surface, a sheet of tinfoil paper and a shinning metal. As indicated in FIG. 4, the reflecting device (5) has a horizontally curved surface; as indicated in FIG. 5, a vertically curved surface of the reflecting device (5) has a straight line instead of a curved line. The reflecting device (5) is located on another inner wall surface of the casing (1) opposite the window (10); the opposite position of the space is provided for the viewer to look through the window (10), the tube (11) and then at the reflecting device (5). A concaved side (50) of the horizontal curved line faces the direction of the window (10).

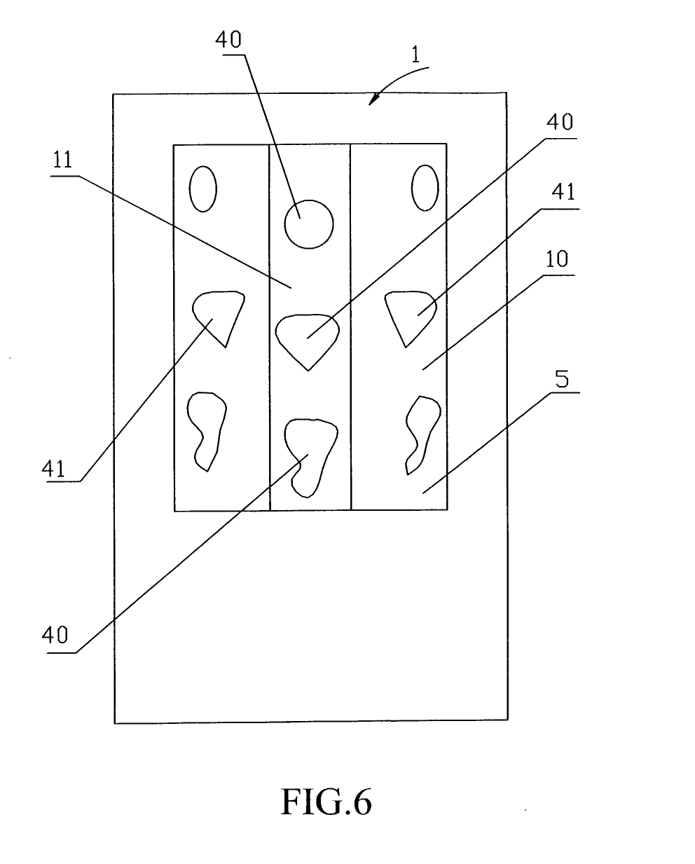

Referring also to FIGS. 6, the design of the present invention of the decoration device of a wax lamp with shadowy variations mainly comprises a reflecting device (5) combined with a conventional wax lamp structure to achieve the effect of producing multiple shadows and variations. The power source supplier (2) provides a certain amount of electricity onto the heating device (3) and a proper amount of temperature to the bottom end of the decorative float vessel (4) thereby driving the transparent liquid inside the tube (11) and the decorative float vessel (4) to convect due to the uneven heat so as to lead the decorative floats (40) to make floating motion. The reflecting device (5) has a horizontal curved side; the reflected decorative floats (41) have the shapes curving, twisting and deforming outwardly. In addition, the curve of the horizontal curved side is capable of projecting two symmetrical decorative floats (41) thereby fulfilling the demand of producing multiple shadows and variations in the space thereof.

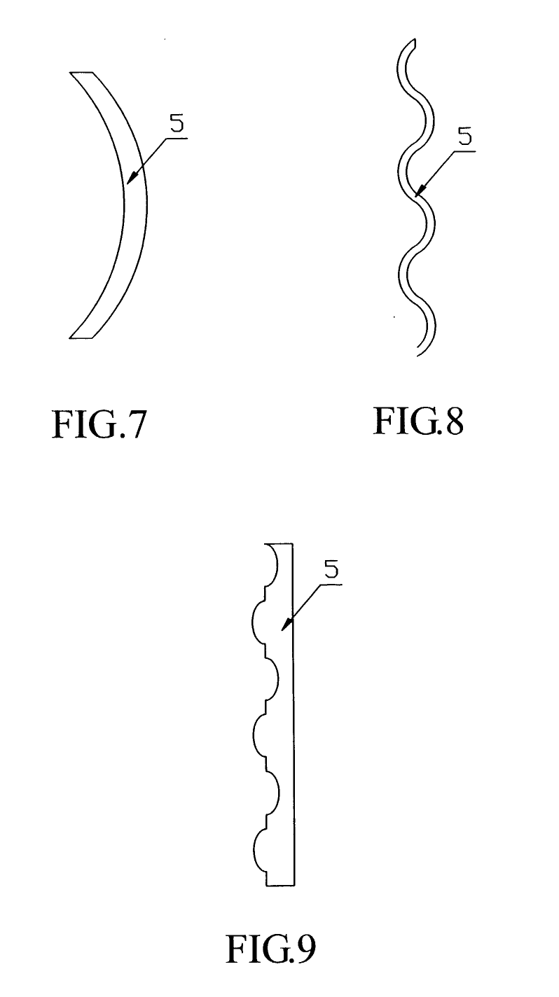

Referring also to FIGS. 7, 8 and 9, the reflecting device (5) of the present invention of the decoration device of a wax lamp with shadowy variations is combined by variably arranging a horizontally curved surface, a vertically curved surface, a vertical wave or layers of lens according to the actual need thereby enabling the decorative floats (40) expand from a linear and reciprocating motion to achieving a function of producing full-area, multiple and variable shadows so as to reach a researcher's or a user's objective of appreciation.

In summation of the abovementioned, the present invention has not only innovative idea, structure and esthetic sense, but also not been previously disclosed. It is of course to be understood that the embodiment described herein is merely illustrative of the principles of the invention and that a wide variety of modifications thereto may be effected by persons skilled in the art without departing from the spirit and scope of the invention as set forth in the following claims.

1. A decoration device of a wax lamp with shadowy variations mainly comprises a casing with a beautiful and curved outer shape formed according to the need to seal onto the outside thereof and to fit with relevant members, such as a power source supplier, a heating device and a decorative float vessel disposed inside the casing as well as a curved reflecting device affixed onto an inner wall surface opposite to a window of the casing; the present invention is characterized that:
the casing has a transparent window for a viewer to see a group motion of decorative floats; an accommodation space is disposed inside the casing through the window; one or more than one tube is disposed to penetrate around the central position area of the accommodation space; a bottom plane at an upper end of the tube seals at the top end of the accommodation space opposite an inner wall surface of the casing; a bottom rim at a lower end of the tube penetrates the accommodation space to communicate with an opening at an upper end of the decorative float vessel; a transparent liquid, such as water, is poured into the tube and the communicated decorative float vessel;
the power source supplier fits with the heating device; when it is necessary, the power source supplier provides equal electric current kinetic energy onto the heating device and a proper amount of temperature to the bottom end of the decorative float vessel;
the opening rim at the upper end of the decorative float vessel is in communication with the tube; the connected inner space between them is filled with a transparent liquid, such as water, and dispersed with the decorative floats for visual enjoyment;
the reflecting device mainly has structures with reflecting mirror functions, such as a mirror surface, a sheet of tinfoil paper and a shinning metal; the reflecting device has a horizontally curved side; the reflecting device is located on another inner wall surface of the casing opposite the window; the opposite position of the space is provided for the viewer to look through the window, the tube and then at the reflecting device; a concaved side of the horizontal curved line faces the direction of the window.

2. The present invention of a decoration device of a wax lamp with shadowy variation according to claim 1, wherein the reflecting device is combined by variably arranging a horizontally curved surface, a vertically curved surface, a vertical wave or layers of lens according to the actual need.

3. The present invention of a decoration device of a wax lamp with shadowy variation according to claim 2, wherein the decorative floats are either made of colored liquid object, such as melted wax, with different density from that of the transparent liquid, or made of a transparent liquid with floating solid bodies and gas, or mixture of both inside.
